(19) United States
(12) Patent Application Publication
(10) Pub. No.: US 2021/0258037 A1
(43) Pub. Date: Aug. 19, 2021

(54) SYSTEMS AND METHODS FOR DIGITAL INTERFERENCE CANCELLATION

(71) Applicant: CommScope Technologies LLC, Hickory, NC (US)

(72) Inventors: Johannes Steigert, Harburg (DE); Daniel Schwab, Gersthofen (DE)

(73) Assignee: CommScope Technologies LLC, Hickory, NC (US)

(21) Appl. No.: 17/160,185

(22) Filed: Jan. 27, 2021

Related U.S. Application Data
(60) Provisional application No. 62/978,413, filed on Feb. 19, 2020.

(51) Int. Cl. H04B 1/525; H04B 1/12; H04B 1/04; H04L 5/14; H04B 3/23

(52) U.S. Cl. CPC H04B 1/525; H04B 1/123; H04B 3/23; H04L 5/1461; H04B 1/0483

(57) ABSTRACT

In one example, a communications device includes transmit and receive signal paths, a duplexer coupled to the transmit and receive signal paths, and a feedback signal path coupled to the transmit signal path, wherein a portion of a transmit signal is decoupled into the feedback signal path as a feedback signal. The communications device further includes ADCs to convert feedback and receive signals to a digital feedback and receive signals. The communications device further includes a digital interference cancellation circuit to receive the digital feedback and receive signals, the digital interference cancellation circuit configured to: modify amplitude and phase of the digital feedback signal to generate a modified feedback signal; compensate the modified feedback signal for an impulse response of a coupling channel to generate a compensated, modified feedback signal; and combine the compensated, modified feedback signal with the digital receive signal to cancel, reduce, attenuate, or eliminate inference.

### CROSS-REFERENCE TO RELATED APPLICATIONS

This application claims the benefit of U.S. Provisional Application Ser. No. 62/978,413, filed Feb. 19, 2020, and titled “SYSTEMS AND METHODS FOR DIGITAL INTERFERENCE CANCELLATION,” which is hereby incorporated herein by reference.

### BACKGROUND

In modern communication networks, mobile devices and base stations include transmitter and receiver sections. The transmitter of the mobile devices operates in the uplink and the receiver of the mobile devices operates in the downlink. The transmitter of the base stations operates in the downlink and the receiver of the base stations operates in the uplink. Depending on the duplexing scheme utilized for communication and the power class of the transceiver, the coupling channel between the transmitter and the receiver differs. In modern communications systems, the transmitter intermodulation products are likely to be a dominant cause of transmitter to receiver crosstalk for the base stations and mobile devices. The isolation requirements for the coupling channel (for example, the duplexer in frequency-division duplexing (FDD) systems or a circulator/switch in time-division duplexing (TDD) systems) for low-power transceivers can be challenging, but the isolation requirements for high-power transceivers are particularly difficult to achieve. For high-power FDD systems, the high isolation requirements require large duplexers and increase development costs and time for duplexer design. Some of the difficulties with duplexer design can be improved using digital cancellation techniques.

### SUMMARY

In one example, a communications device includes a transmit signal path, a receive signal path, and a duplexer communicatively coupled to the transmit signal path and the receive signal path. The duplexer is configured to provide an analog transmit signal to an antenna and to provide an analog receive signal to the receive signal path. The communications device further includes a feedback signal path communicatively coupled to the transmit signal path, wherein a portion of the analog transmit signal is decoupled into the feedback signal path from the transmit signal path as a feedback signal. The communications device further includes analog-to-digital converters configured to convert the feedback signal and the analog receive signal to a digital feedback signal and a digital receive signal. The communications device further includes a digital interference cancellation circuit configured to receive the digital feedback signal and the digital receive signal. The digital interference cancellation circuit is configured to modify the amplitude and phase of the digital feedback signal to generate a modified feedback signal. The digital interference cancellation circuit is further configured to compensate the modified feedback signal for an impulse response of a coupling channel between the transmit signal path and the receive signal path to generate a compensated, modified feedback signal. The digital interference cancellation circuit is further configured to combine the compensated, modified feedback signal with the digital receive signal, wherein combination of the compensated, modified feedback signal with the receive signal cancels, reduces, attenuates, or eliminates inference in the digital receive signal.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an example communications device;

FIG. 2 is a block diagram of an example digital interference cancellation circuit;

FIGS. 3A-3B are block diagrams of example calibration systems for the digital interference cancellation circuit;

FIG. 4 is a block diagram of an example distributed antenna system including a digital interference cancellation circuit; and

FIG. 5 is a block diagram of an example single-node repeater including a digital interference cancellation circuit.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. The following detailed description is, therefore, not to be taken in a limiting sense.

One limitation of current dynamic digital cancellation techniques is that the adaption of the filter(s) is only performed at the interfering frequencies. For multi-carrier, multi-operator systems, the receiver interference is neither static nor predictable. Current techniques do no enable hardware manufacturers to ensure regulatory compliant operation of dynamic digital cancellation systems based on design, and it is difficult to utilize dynamic digital cancellation when this cannot be guaranteed.

The example systems and methods described herein improve digital cancellation of interference over the full frequency range of a receiver using digital processing. In some examples described herein, static calibration of the system is utilized in combination with dynamic calibration during operation. In some examples, a broadband White Gaussian Noise signal is used to calibrate the digital interference cancellation circuit such that no major changes (risk) are expected in the field during operation. Thus, these example systems and methods alleviate the concerns with current adaptive methods that address only the current intermodulation distortion.

In some examples, the system includes a digital interference cancellation circuit that modifies the amplitude and phase of a feedback signal and convolutes the modified feedback signal with an impulse response of a duplexer and one or more radio frequency components (or other coupling channels between the transmitter and receiver). Such a digital interference cancellation circuit further combines the convoluted, modified feedback signal with the receive signal to cancel, reduce, attenuate, or eliminate inference in the receive signal. In some examples, the digital interference cancellation circuit further includes an adaptive filter that applies a transfer function that is statically calibrated to account for variations in production and aging. In some examples, the amplitude and/or phase modifications performed by the digital interference cancellation circuit are dynamically calibrated during operation using an internal signal generator in order to account for the effects of environment or aging during operation.

In other examples, the system includes a digital interference cancellation circuit that modifies the amplitude and phase of a feedback signal and includes an adaptive filter that applies a transfer function that is statically calibrated, which accounts for the impulse response of coupling channels in addition to variations in production and aging. In some such examples, the amplitude and/or phase modifications performed by the digital interference cancellation circuit are dynamically calibrated during operation using an internal signal generator in order to account for the effects of environment or aging during operation.

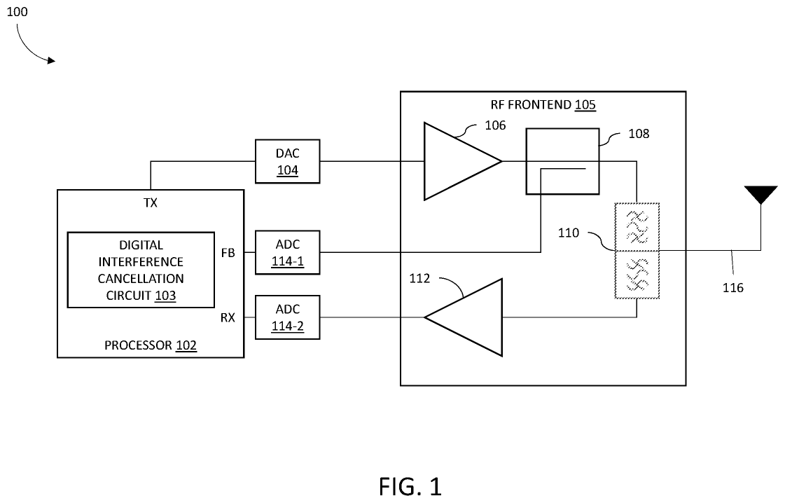

FIG. 1 is a block diagram of an example communication device 100. In the example of FIG. 1, the communications device 100 includes a processor 102 having a digital interference cancellation circuit 103, a digital-to-analog converter 104, a power amplifier 106, a directional coupler 108, a duplexer 110, a low-noise amplifier 112, and two analog-to-digital converters 114-1, 114-2. While a single instance of each component is shown in FIG. 1, it should be understood that this is for ease of illustration and the communications device 100 can include one or more of the components shown in FIG. 1. For example, a communications device 100 may include multiple transmit or receive signal paths and corresponding inputs/outputs to the processor 102. Other components not shown in FIG. 1 can also be included in the signal paths depending on the requirements or desired operation of the communications device 100.

In the example shown in FIG. 1, the processor 102 includes a transmit output (TX), a feedback input (FB), and receive input (RX). The processor 102 further comprises a digital interference cancellation circuit 103 configured to digitally cancel, reduce, attenuate, or eliminate interference from the signals received by the communications device 100. In some examples, the processor 102 is a field-programmable gate array (FPGA).

In the example shown in FIG. 1, the digital-to-analog converter 104 is communicatively coupled to the transmit output of the processor 102. The digital-to-analog converter 104 is configured to convert the signals output by the processor 102 to analog signals. In some examples, the digital-to-analog converter 104 is configured to convert a digital transmit signal output by the processor 102 to an analog transmit signal. In some examples, the digital-to-analog converter 104 is configured to convert a digital calibration signal output by the processor 102 to an analog calibration signal.

In the example shown in FIG. 1, the power amplifier 106 is coupled to the digital-to-analog converter 104 in the transmit signal path of the RF frontend 105 and is configured to increase the power level of the analog transmit signal. In some examples, the power amplifier 106 is a high-power amplifier. In other examples, the power amplifier 106 is a low-power or medium-power amplifier.

In the example shown in FIG. 1, the transmit signal path of the RF frontend 105 further includes a directional coupler 108. In some examples, the directional coupler 108 is configured to decouple a portion of the analog transmit signal into a feedback signal path as a feedback signal. The feedback signal is provided to the analog-to-digital converter 114-1 that is communicatively coupled to the directional coupler 108. The analog-to-digital converter 114-1 is configured to convert the feedback signal to a digital signal.

In the example shown in FIG. 1, the transmit signal path is coupled to a duplexer 110, which is coupled to an antenna 116. The duplexer 110 is configured to provide the analog transmit signal to the antenna 116 for radiation into a coverage area. The duplexer 110 is also configured to receive an analog receive signal from the antenna 116 and provide the analog receive signal to the receive signal path of the communications device 100.

In the example shown in FIG. 1, the receive signal path of the RF frontend 105 includes a low-noise amplifier 112 coupled to the duplexer 110 and configured to increase the power level of the analog receive signal. The analog receive signal is provided to the analog-to-digital converter 114-2 that is communicatively coupled to the low-noise amplifier 112. The analog-to-digital converter 114-1 is configured to convert the receive signal to a digital signal.

The digital interference cancellation circuit 103 is configured to receive the feedback signal from the feedback signal path and the receive signal from the receive signal path. In practice, the receive signal will include interference as well as the intended receive signal. For example, the interference can be caused by the transmit signal path and then leaked through the coupling channel(s) into the receive signal path. In some examples, the digital interference cancellation circuit 103 is configured to cancel, reduce, attenuate, or eliminate the interference from the receive signal, which can increase the signal-to-noise ratio of the communications device 100 and/or reduce the isolation requirements for the duplexer 110.

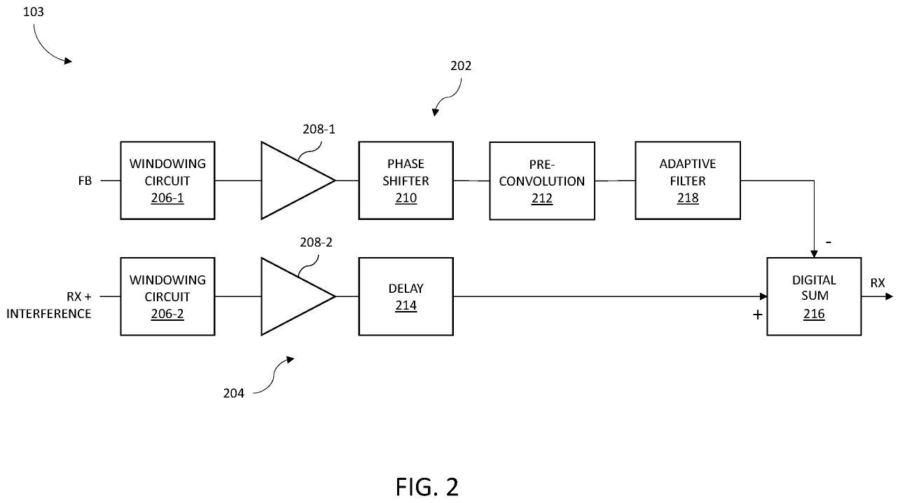

FIG. 2 is a block diagram of an example implementation of the digital interference cancellation circuit 103 included in the processor 102 shown in FIG. 1. The digital interference cancellation circuit 103 includes a feedback signal path 202 and a receive signal path 204. In the example shown in FIG. 2, the feedback signal path 202 includes a windowing circuit 206-1, an amplitude-offset block 208-1, a phase shifter 210, a pre-convolution circuit 212, and an adaptive filter 218. In the example shown in FIG. 2, the receive signal path 204 includes a windowing circuit 206-2, an amplitude-offset block 208-2, an optional time-delay device 214, and a digital summation 216.

In the example shown in FIG. 2, the windowing circuits 206-1, 206-2 are configured to receive the feedback signal and the receive signal from the analog-to-digital converters 114-1, 114-2, respectively. In some examples, the windowing circuits 206-1, 206-2 are configured to window the feedback signal and the receive signal (including interference), respectively, discussed above with respect to FIG. 1. In some examples, the windowing circuits 206-1, 206-2 are included to overcome spectral widening related to non-periodic signals fed to the analog-to-digital converters 214-1, 214-2.

In the example shown in FIG. 2, the amplitude-offset blocks 208-1, 208-2 are configured to receive the output of the windowing circuits 206-1, 206-2. In some examples, the amplitude-offset blocks 208-1, 208-2 are configured to calibrate the signal amplitude of the feedback signal and receive signal, respectively, by adjusting the amplitude of the feedback signal and the receive signal. In some examples, the amplitude of the feedback signal and/or the receive signal is adjusted to compensate for losses and differences in the analog-to-digital converters 114-1, 114-2.

In the example shown in FIG. 2, the phase shifter 210 is configured to receive the output of the amplitude-offset block 208-1. In some examples, the phase shifter 210 is configured to calibrate the phase of the feedback signal by adjusting the phase of the feedback signal. In some examples, the phase of the feedback signal is adjusted to compensate for a phase offset between the analog-to-digital converters 114-1, 114-2. The output of the phase shifter 210 is referred to herein as a modified feedback signal.

In the example shown in FIG. 2, the pre-convolution circuit 212 is configured to receive the modified feedback signal from the phase shifter 210 and convolute the modified feedback signal with the impulse response of the duplexer and/or one or more radio frequency components in the receive signal path (for example, the LNA). In some examples, the impulse response is determined based on the scattering parameters of the duplexer and LNA (or other coupling channels). Manufacturers can measure the scattering parameters of the duplexer, low-noise amplifier, and/or other RF components of the receive signal path (or other coupling channels) during production. In some examples, the impulse response is approximated by applying an inverse Fourier transform (for example, an inverse fast Fourier transform (IFFT)) to the scattering parameters of the duplexer, LNA, and/or other RF components because the scattering parameters represent the frequency domain counterpart of the impulse response.

In the example shown in FIG. 2, the optional time-delay device 214 may be configured to receive the signal from the amplitude-offset block 208-2 and apply an optional time delay to the receive signal path so the corresponding samples of the feedback signal and the receive signal are received by the digital summation 216 at the same time. In general, to avoid additional delay within the receive path, the time-delay device 214 can be bypassed or excluded from the digital interference cancellation circuit 103.

In the example shown in FIG. 2, the digital summation 216 is configured to receive the convoluted, modified feedback signal from the feedback signal path 202 and the modified receive signal from the receive signal path 204. The digital summation 216 is configured to combine the convoluted, modified feedback signal and the modified receive signal, which still includes interference, in order to cancel, reduce, attenuate, or eliminate the interference from the receive signal. The output of the digital summation 216 is the receive signal where interference due to transmitter to receiver leakage is canceled, reduced, attenuated, or eliminated.

In practice, production-related variations and aging can cause non-negligible amplitude and phase differences between the feedback signal and the receive signal even after calibration with the components of the feedback signal path 202. These differences could reduce the effectiveness of the digital interference cancellation circuit 103 over time. This could potentially lead to an increased impact of interference if the interferers are constructively superimposed due to the amplitude and phase differences. To alleviate these issues, in some examples, the feedback signal path 202 of the digital interference cancellation circuit 103 includes an adaptive filter 218 coupled between the pre-convolution circuit 212 and the digital summation 216. The adaptive filter 218 is configured to optimize the adjustments to the amplitude and phase of the feedback signal in order to better calibrate the feedback signal for canceling, reducing, attenuating, or eliminating interference. A number of adaptive filter techniques could be used to determine the adjustments to the amplitude and phase of the feedback signal to compensate for the production-related variations and aging. For example, a least mean square (LMS) filter, a normalized LMS (NLMS) filter, a recursive least squares (RLS) filter, or the like could be used.

In some examples, the pre-convolution circuit 212 can be bypassed or omitted from the digital interference cancellation circuit 103. For example, the adaptive filter 218 can be coupled to the phase shifter 210 in the feedback signal path 202 of the digital interference cancellation circuit 103. In such examples, the adaptive filter 218 is used to compensate for the impulse response of the duplexer, LNA, and/or other RF components while optimizing the adjustments to the amplitude and phase of the feedback signal in order to better calibrate the feedback signal for canceling, reducing, attenuating, or eliminating interference.

In some examples, the value of the amplitude offset applied by the amplitude-offset blocks 208-1, 208-2 and/or the value of the phase offset applied by the phase shifter 210 can be temperature compensated. In some examples, the communications device 100 includes a temperature sensor (not shown) to obtain a current temperature of the radio-frequency system. In such examples, the value of the amplitude offset applied by the amplitude-offset blocks 208-1, 208-2 and/or the value of the phase offset applied by the phase shifter 210 is adjusted based on the current temperature.

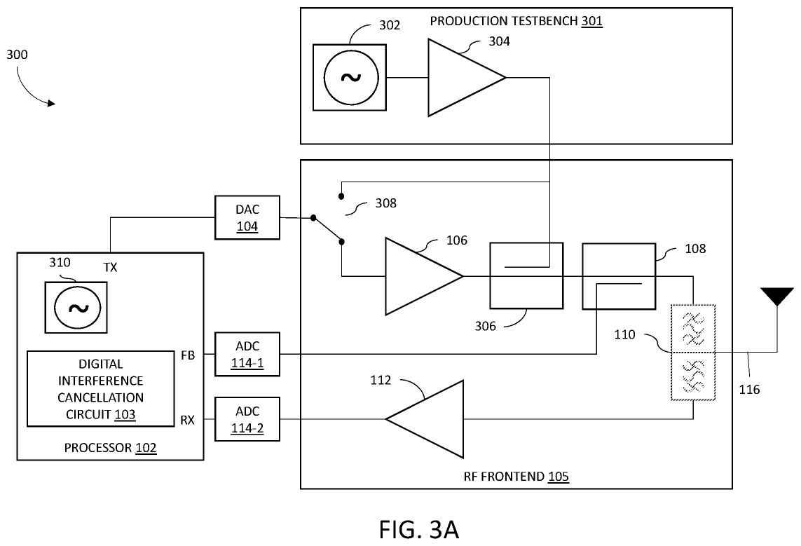

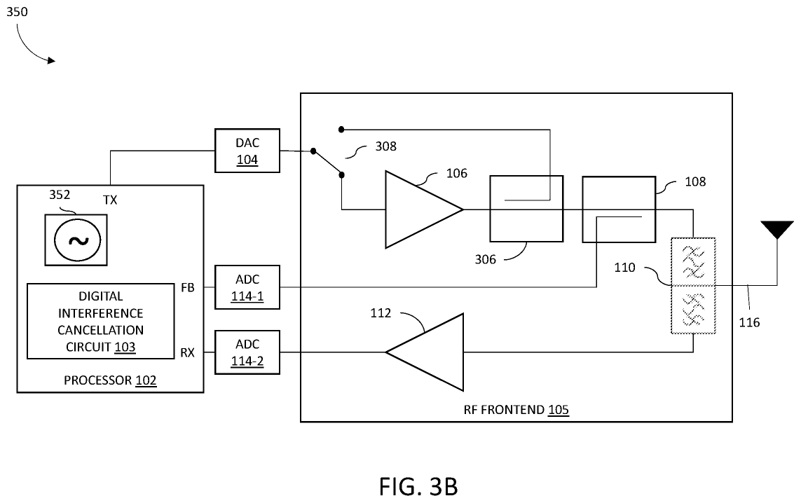

In order to calibrate the digital interference cancellation circuit 103, a few different architectures can be used depending on the level of power for the particular communications device 100. FIGS. 3A-3B are block diagrams of example calibration systems 300, 350 for the digital interference cancellation circuit 103 shown in FIGS. 1-2. The features of the communications device 100 are included in FIGS. 3A-3B and the components of the communications device 100 have the same reference numeral as included in FIG. 1.

In the example shown in FIG. 3A, the calibration system 300 includes a production testbench 301. The production testbench 301 includes a White Gaussian Noise generator 302. In some examples, the White Gaussian Noise generator 302 is configured to generate a band-limited White Gaussian Noise signal that is bandwidth limited to the desired receive frequency range. In some examples, the White Gaussian Noise generator 302 is configured to generate a broadband noise signal that covers the full bandwidth in which digital cancellation must be provided by the digital interference cancellation circuit 103. For example, the White Gaussian Noise generator 302 can be configured to generate a White Gaussian Noise signal having a bandwidth of 60 MHz for a communications device 100 configured to operate using a Long-Term Evolution (LTE) air interface protocol. Signals with different bandwidths could also be used as well as different air interface protocols.

For high-power applications, it can be difficult to generate a White Gaussian Noise signal at a high enough power level to be useful for the calibration using a signal generator alone. In some examples, the production testbench 301 further includes a power amplifier 304 configured to increase the power level of the White Gaussian Noise signal prior to the signal being provided to the RF frontend 105. In low-power or medium-power applications, the power amplifier 304 can be omitted from the production testbench 301.

The White Gaussian Noise signal generated by the White Gaussian Noise generator 302 is injected into the downlink signal path of the RF frontend 105 via a directional coupler 306. In some examples, the components of the production testbench 301 are coupled to the directional coupler 306 via a connector (not shown) of the RF frontend 105. In some examples, an RF connector of the production testbench 301 is coupled to an RF connector of the RF frontend 105 via a cable.

During calibration with the production testbench 301, the feedback signal provided to the digital interference cancellation circuit 103 will include the White Gaussian Noise signal and the receive signal provided to the digital interference cancellation circuit 103 will include a muted portion of the same White Gaussian Noise signal (referred to herein as Tx leakage). The coefficients of the adaptive filter 218, which determine the transfer function of the adaptive filter 218, of the digital interference cancellation circuit 103 are iteratively modified based on the White Gaussian Noise signal in the feedback signal path and the received Tx leakage signal in the receive signal path. In some examples, the calibration of the adaptive filter 218 is performed until the interference cancellation provided by the digital interference cancellation circuit 103 converges to a desired value. In some examples, the desired value is selected based on complete cancellation of the interference signal received during the calibration process. In other examples, the desired value is selected such that the interference is reduced or attenuated at a sufficient level to satisfy system requirement. For example, the desired value for interference remaining at the output of the digital summation 216 can be selected to lower the Tx leakage at the receiver by 20 dB. Once the cancellation provided by the digital interference cancellation circuit 103 converges to the desired value, the calibration is ceased and the coefficients of the adaptive filter 218 are statically set for operation.

After installation of the communications device 100, a number of issues can affect the cancellation of interference by the digital interference cancellation circuit 103 during operation of the communications device 100. For example, the antenna 116 and/or cable connecting the RF frontend 105 to the antenna 116 may not represent a perfect termination or varying environmental conditions or aging may occur. These issues can vary compared to the production calibration conditions and degrade the level of cancellation provided by the digital interference cancellation circuit 103. To compensate for this degradation, the communications device 100 can further include an onboard calibration mechanism.

In the example shown in FIG. 3A, the RF frontend 105 further includes a switch 308 coupled between the digital-to-analog converter 104 and the power amplifier 106 and an internal signal generator 310 implemented by the processor 102. When a degradation of the cancellation value is detected (for example, when the signal-to-noise ratio exceeds a threshold), the transmit signal is turned off by the processor 102 and the switch 308 is switched to connect the transmit output of the processor 102 to the directional coupler 306. In some examples, the internal signal generator 310 is configured to generate a calibration signal that is injected into the transmit signal path via the directional coupler 306. In some examples, the calibration signal is a continuous wave tone at a particular frequency. In some examples, the frequency of the calibration signal is selected to be in the canceled frequency range.

During onboard calibration, the feedback signal provided to the digital interference cancellation circuit 103 via the feedback signal path will include the calibration signal and the receive signal provided to the digital interference cancellation circuit 103 will include a Tx leakage signal. The calibration signal is used to modify one or more components of the digital interference cancellation circuit 103 (for example, the amplitude-offset blocks 208-1, 208-2 and the phase shifter 210).

In some examples, the coefficients of the adaptive filter 218 of the digital interference cancellation circuit 103 are iteratively modified based on the calibration signal received via the feedback signal path and the received Tx leakage signal in the receive signal path. In some examples, the adjustment of the adaptive filter 218 coefficients is performed until the cancellation provided by the digital interference cancellation circuit 103 converges to a desired value. In some examples, the desired value is the same as that used for production calibration. In other examples, the desired value is different than the value used for production calibration. Once the cancellation provided by the digital interference cancellation circuit 103 converges to the desired value, the calibration is ceased and the coefficients of the adaptive filter 218 are set to the updated values for operation.

In some examples, the amplitude-offset-block 208-1 and/or the phase shifter 210 are modified using the calibration signal from the feedback signal path and the Tx leakage signal from the receive signal path in addition to (or instead of) modifying the coefficients of the adaptive filter 218. For example, the value of the amplitude-offset applied by the amplitude-offset blocks 208-1, 208-2 and/or the value of the phase offset applied by the phase shifter 210 can be iteratively modified to provide better cancellation of the interference signal. In some examples, the amplitude-offset blocks 208-1, 208-2 and the phase shifter 210 are modified until the cancellation provided by the digital interference cancellation circuit 103 converges to a desired value. In some examples, the desired value is the same as that used for production calibration. In other examples, the desired value is different than the value used for production calibration. Once the cancellation provided by the digital interference cancellation circuit 103 converges to the desired value, the onboard calibration is ceased, and the value of the amplitude offset applied by the amplitude-offset blocks 208-1, 208-2 and/or the value of the phase offset applied by the phase shifter 210 are set for operation.

Following completion of the onboard calibration process, the processor 102 is configured to switch the switch 308 in order to couple the transmit output of the processor 102 to the power amplifier 106. The processor 102 is configured to turn on the transmit signal to resume normal operation of the communications device 100.

FIG. 3B is a block diagram of another example calibration system 350 for the digital interference cancellation circuit 103 shown in FIGS. 1-2. The calibration system 350 includes similar components to the calibration system 300 of FIG. 3A and the common features are numbered similarly.

For low-power or medium-power applications, an internal signal generator can produce a White Gaussian Noise signal at a sufficient power level for production calibration. In the example shown in FIG. 3B, the communications device 100 includes an internal signal generator 352 that is used for both production calibration and onboard calibration.

For production calibration, the internal signal generator 352 is configured to generate a White Gaussian Noise signal that is injected into the transmit signal path of the RF frontend 105 via a directional coupler 306. In some examples, the internal signal generator 352 is configured to generate a band-limited White Gaussian Noise signal that is bandwidth limited to the desired receive frequency range. In some examples, the internal signal generator 352 is configured to generate a broadband noise signal that covers the full bandwidth in which digital cancellation must be provided by the digital interference cancellation circuit 103. For example, the internal signal generator 352 can be configured to generate a White Gaussian Noise signal having a bandwidth of 60 MHz for a communications device 100 configured to operate using a Long-Term Evolution (LTE) air interface protocol. Signals with different bandwidths could also be used as well as different air interface protocols.

For onboard calibration, the internal signal generator 352 is configured to generate a calibration signal that is injected into the transmit signal path via the directional coupler 306. In some examples, the calibration signal is a continuous wave tone at a particular frequency. In some examples, the frequency of the calibration signal is selected to be in the canceled frequency range.

During production calibration, the switch 308 is switched to connect the transmit output of the processor 102 to the directional coupler 306 in the example shown in FIG. 3B. Further, the feedback signal provided to the digital interference cancellation circuit 103 will include the White Gaussian Noise signal and the receive signal provided to the digital interference cancellation circuit 103 will include a muted portion of the same White Gaussian Noise signal (referred to herein as Tx leakage). The coefficients of the adaptive filter 218 of the digital interference cancellation circuit 103 are iteratively modified based on the White Gaussian Noise signal in the feedback signal path and the Tx leakage signal in the receive signal path. In some examples, the calibration of the adaptive filter 218 is performed until the interference cancellation provided by the digital interference cancellation circuit 103 converges to a desired value. In some examples, the desired value is selected based on complete cancellation of the interference signal received during the calibration process. In other examples, the desired value is selected such that the interference is reduced or attenuated at a sufficient level to satisfy system requirement. For example, the desired value for interference suppression at the output of the digital summation 216 can be selected to be at least 20 dB. Once the cancellation provided by the digital interference cancellation circuit 103 converges to the desired value, the calibration is ceased and the coefficients of the adaptive filter 218 are statically set for operation.

When a degradation of the cancellation value is detected during operation (for example, when the signal-to-noise ratio exceeds a threshold), the transmit signal is turned off by the processor 102 and the switch 308 is switched to connect the transmit output of the processor 102 to the directional coupler 306. During onboard calibration for the system shown in FIG. 3B, the feedback signal provided to the digital interference cancellation circuit 103 will include the calibration signal generated by the internal signal generator 352 and the receive signal provided to the digital interference cancellation circuit 103 will include a Tx leakage signal. The calibration signal is used to modify one or more components of the digital interference cancellation circuit 103 (for example, the amplitude-offset blocks 208-1, 208-2 and the phase shifter 210).

In some examples, the coefficients of the adaptive filter 218 of the digital interference cancellation circuit 103 are iteratively modified based on the calibration signal received via the feedback signal path and the received interference signal in the receive signal path. In some examples, the adjustment of the adaptive filter 218 coefficients is performed until the cancellation provided by the digital interference cancellation circuit 103 converges to a desired value. In some examples, the desired value is the same as that used for production calibration. In other examples, the desired value is different than the value used for production calibration. Once the cancellation provided by the digital interference cancellation circuit 103 converges to the desired value, the calibration is ceased and the coefficients of the adaptive filter 218 are set to the updated values for operation.

In some examples, the amplitude-offset blocks 208-1, 208-2 and/or the phase shifter 210 are modified using the calibration signal from the feedback signal path and the Tx leakage signal from the receive signal path in addition to (or instead of) modifying the coefficients of the adaptive filter 218. For example, the value of the amplitude-offset applied by the amplitude-offset blocks 208-1, 208-2 and/or the value of the phase offset applied by the phase shifter 210 can be iteratively modified to provide better cancellation of the interference signal. In some examples, the amplitude-offset blocks 208-1, 208-2 and the phase shifter 210 are modified until the cancellation provided by the digital interference cancellation circuit 103 converges to a desired value. In some examples, the desired value is the same as that used for production calibration. In other examples, the desired value is different than the value used for production calibration. Once the cancellation provided by the digital interference cancellation circuit 103 converges to the desired value, the onboard calibration is ceased, and the value of the amplitude-offset applied by the amplitude-offset blocks 208-1, 208-2 and/or the value of the phase offset applied by the phase shifter 210 are set for operation.

Following completion of the onboard calibration process, the processor 102 is configured to switch the switch 308 in order to couple the transmit output of the processor 102 to the power amplifier 106. The processor 102 is configured to turn on the transmit signal to resume normal operation of the communications device 100.

The digital interference cancellation circuit 103 and calibration techniques described above can be used in conjunction with any number of RF circuits and system architectures such as, but not limited to: wireless network access points, distributed antenna systems, RF repeaters, cellular communications base stations, and small cell base stations.

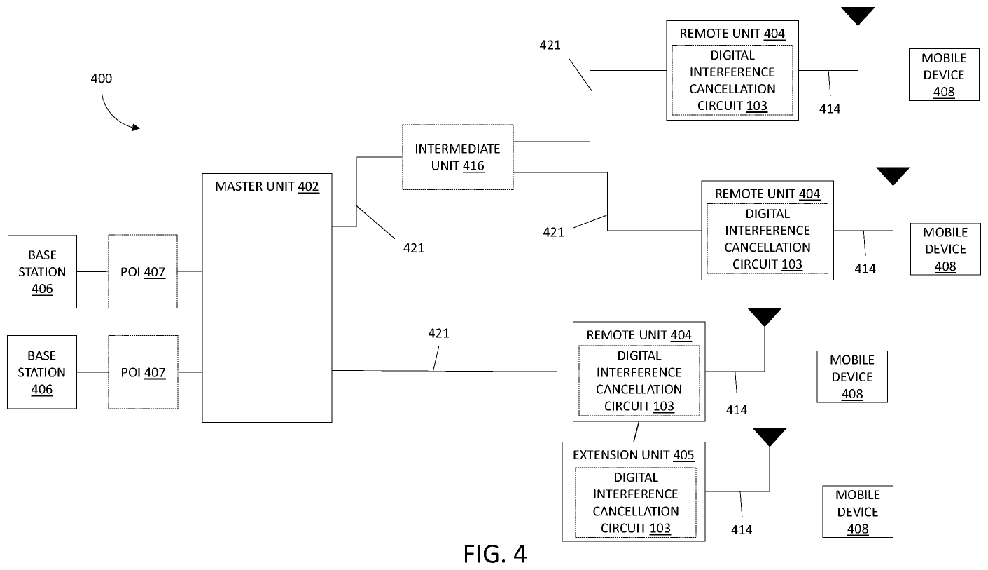

FIG. 4 is a block diagram of an example distributed antenna system (DAS) 400 that includes the digital interference cancellation circuit 103 in one or more components. In the example of FIG. 4, the distributed antenna system 400 includes a master unit 402 communicatively coupled to one or more remote antenna units 404.

In the example of FIG. 4, the DAS 400 includes one or more master units 402 (also referred to as “host units” or “central area nodes” or “central units”) and one or more remote antenna units 404 (also referred to as “remote units” or “radiating points”) that are communicatively coupled to the one or more master units 402. In this example, the DAS 400 comprises a digital DAS, in which DAS traffic is distributed between the master units 402 and the remote antenna units 404 in digital form. The DAS 400 can be deployed at a site to provide wireless coverage and capacity for one or more wireless network operators. The site may be, for example, a building or campus or other grouping of buildings (used, for example, by one or more businesses, governments, or other enterprise entities) or some other public venue (such as a hotel, resort, amusement park, hospital, shopping center, airport, university campus, arena, or an outdoor area such as a ski area, stadium or a densely-populated downtown area).

The master unit 402 is communicatively coupled to the plurality of base stations 406. One or more of the base stations 406 can be co-located with the respective master unit 402 to which it is coupled (for example, where the base station 406 is dedicated to providing base station capacity to the DAS 400). Also, one or more of the base stations 406 can be located remotely from the respective master unit 402 to which it is coupled (for example, where the base station 406 is a macro base station providing base station capacity to a macro cell in addition to providing capacity to the DAS 400). In this latter case, a master unit 402 can be coupled to a donor antenna using an over-the-air repeater in order to wirelessly communicate with the remotely located base station.

The base stations 406 can be implemented in a traditional manner in which a base band unit (BBU) is deployed at the same location with a radio head (RRH) to which it is coupled, where the BBU and RRH are coupled to each other using optical fibers over which front haul data is communicated as streams of digital IQ samples (for example, in a format that complies with one of the Common Public Radio Interface (CPRI), Open Base Station Architecture Initiative (OBSAI), and Open RAN (0-RAN) families of specifications). Also, the base stations 406 can be implemented in other ways (for example, using a centralized radio access network (C-RAN) topology where multiple BBUs are deployed together in a central location, where each of BBU is coupled to one or more RRHs that are deployed in the area in which wireless service is to be provided. Also, the base station 406 can be implemented as a small cell base station in which the BBU and RRH functions are deployed together in a single package.

The master unit 402 can be configured to use wideband interfaces or narrowband interfaces to the base stations 406. Also, the master unit 402 can be configured to interface with the base stations 406 using analog radio frequency (RF) interfaces or digital interfaces (for example, using a CPRI, OBSAI, or O-RAN digital interface). In some examples, the master unit 402 interfaces with the base stations 406 via one or more wireless interface nodes (not shown). A wireless interface node can be located, for example, at a base station hotel, and group a particular part of a RF installation to transfer to the master unit 402.

Traditionally, a master unit 402 interfaces with one or more base stations 406 using the analog radio frequency signals that each base station 406 communicates to and from a mobile device 408 (also referred to as “mobile units” or “user equipment”) of a user using a suitable air interface standard. Although the devices 408 are referred to here as “mobile” devices 408, it is to be understood that the devices 408 need not be mobile in ordinary use (for example, where the device 408 is integrated into, or is coupled to, a sensor unit that is deployed in a fixed location and that periodically wirelessly communicates with a gateway or other device). The DAS 400 operates as a distributed repeater for such radio frequency signals. RF signals transmitted from each base station 406 (also referred to herein as “downlink RF signals”) are received at the master unit. In such examples, the master unit 402 uses the downlink RF signals to generate a downlink transport signal that is distributed to one or more of the remote antenna units 404. Each such remote antenna unit 404 receives the downlink transport signal and reconstructs a version of the downlink RF signals based on the downlink transport signal and causes the reconstructed downlink RF signals to be radiated from an antenna 414 coupled to or included in that remote antenna unit 404.

In some aspects, the master unit 402 is directly coupled to the remote antenna units 404. In such aspects, the master unit 402 is coupled to the remote antenna units 404 using cables 421. For example, the cables 421 can include optical fiber or Ethernet cable complying with the Category 5, Category 5e, Category 6, Category 6A, or Category 7 specifications. Future communication medium specifications used for Ethernet signals are also within the scope of the present disclosure.

A similar process can be performed in the uplink direction. RF signals transmitted from mobile devices 408 (also referred to herein as “uplink RF signals”) are received at one or more remote antenna units 404 via an antenna 414. Each remote antenna unit 404 uses the uplink RF signals to generate an uplink transport signal that is transmitted from the remote antenna unit 404 to a master unit 402. The master unit 402 receives uplink transport signals transmitted from one or more remote antenna units 404 coupled to it. The master unit 402 can combine data or signals communicated via the uplink transport signals from multiple remote antenna units 404 (for example, where the DAS 400 is implemented as a digital DAS 400, by digitally summing corresponding digital samples received from the various remote antenna units 404) and generates uplink RF signals from the combined data or signals. In such examples, the master unit 402 communicates the generated uplink RF signals to one or more base stations 406. In this way, the coverage of the base stations 406 can be expanded using the DAS 400.

As noted above, in the example shown in FIG. 4, the DAS 400 is implemented as a digital DAS. In a “digital” DAS, signals received from and provided to the base stations 406 and mobile devices 408 are used to produce digital in-phase (I) and quadrature (Q) samples, which are communicated between the master unit 402 and remote antenna units 404. It is important to note that this digital IQ representation of the original signals received from the base stations 406 and from the mobile units still maintains the original modulation (that is, the change in the amplitude, phase, or frequency of a carrier) used to convey telephony or data information pursuant to the cellular air interface protocol used for wirelessly communicating between the base stations 406 and the mobile units. Examples of such cellular air interface protocols include, for example, the Global System for Mobile Communication (GSM), Universal Mobile Telecommunications System (UMTS), High-Speed Downlink Packet Access (HSDPA), Long-Term Evolution (LTE), Citizens Broadband Radio Service (CBRS), and fifth generation New Radio (5G NR) air interface protocols. Also, each stream of digital IQ samples represents or includes a portion of wireless spectrum. For example, the digital IQ samples can represent a single radio access network carrier (for example, a 5G NR carrier of 40 MHz or 400 MHz) onto which voice or data information has been modulated using a 5G NR air interface. However, it is to be understood that each such stream can also represent multiple carriers (for example, in a band of frequency spectrum or a sub-band of a given band of frequency spectrum).

In the example shown in FIG. 4, the master unit 402 can be configured to interface with one or more base stations 406 using an analog RF interface (for example, via the analog RF interface of an RRH or a small cell base station). In some examples, the base stations 406 can be coupled to the master unit 402 using a network of attenuators, combiners, splitters, amplifiers, filters, cross-connects, etc., which is referred to collectively as a point-of-interface (POI) 407. This is done so that, in the downlink, the desired set of RF carriers output by the base stations 406 can be extracted, combined, and routed to the appropriate master unit 402, and so that, in the uplink, the desired set of carriers output by the master unit 402 can be extracted, combined, and routed to the appropriate interface of each base station 406. In other examples, the POI 407 can be part of the master unit 402.

In the example shown in FIG. 4, in the downlink, the master unit 402 can produce digital IQ samples from an analog signal received at radio frequency (RF) by down-converting the received signal to an intermediate frequency (IF) or to baseband, digitizing the down-converted signal to produce real digital samples, and digitally down-converting the real digital samples to produce digital in-phase (I) and quadrature (Q) samples. These digital IQ samples can also be filtered, amplified, attenuated, and/or re-sampled or decimated to a lower sample rate. The digital samples can be produced in other ways. Each stream of digital IQ samples represents a portion of radio frequency spectrum output by one or more base stations 406. Each portion of radio frequency spectrum can include, for example, a band of wireless spectrum, a sub-band of a given band of wireless spectrum, or an individual wireless carrier.

Likewise, in the uplink, the master unit 402 can produce an uplink analog signal from one or more streams of digital IQ samples received from one or more remote antenna units 404 by digitally combining streams of digital IQ samples that represent the same carriers or frequency bands or sub-bands received from multiple remote antenna units 404 (for example, by digitally summing corresponding digital IQ samples from the various remote antenna units 404), digitally up-converting the combined digital IQ samples to produce real digital samples, performing a digital-to-analog process on the real samples in order to produce an IF or baseband analog signal, and up-converting the IF or baseband analog signal to the desired RF frequency. The digital IQ samples can also be filtered, amplified, attenuated, and/or re-sampled or interpolated to a higher sample rate, before and/or after being combined. The analog signal can be produced in other ways (for example, where the digital IQ samples are provided to a quadrature digital-to-analog converter that directly produces the analog IF or baseband signal).

In the example shown in FIG. 4, the master unit 402 can be configured to interface with one or more base stations 406 using a digital interface (in addition to, or instead of) interfacing with one or more base stations 406 via an analog RF interface. For example, the master unit 402 can be configured to interact directly with one or more BBUs using the digital IQ interface that is used for communicating between the BBUs and an RRHs (for example, using the CPRI serial digital IQ interface).

In the downlink, the master unit 402 terminates one or more downlink streams of digital IQ samples provided to it from one or more BBUs and, if necessary, converts (by re-sampling, synchronizing, combining, separating, gain adjusting, etc.) them into downlink streams of digital IQ samples compatible with the remote antenna units 404 used in the DAS 400. In the uplink, the master unit 402 receives uplink streams of digital IQ samples from one or more remote antenna units 404, digitally combining streams of digital IQ samples that represent the same carriers or frequency bands or sub-bands received from multiple remote antenna units 404 (for example, by digitally summing corresponding digital IQ samples received from the various remote antenna units 404), and, if necessary, converts (by re-sampling, synchronizing, combining, separating, gain adjusting, etc.) them into uplink streams of digital IQ samples compatible with the one or more BBUs that are coupled to that master unit 402.

In the downlink, each remote antenna unit 404 receives streams of digital IQ samples from the master unit 402, where each stream of digital IQ samples represents a portion of wireless radio frequency spectrum output by one or more base stations 406. Each remote antenna unit 404 generates, from the downlink digital IQ samples, one or more downlink RF signals for radiation from the one or more antennas coupled to that remote antenna unit 404 for reception by any mobile devices 408 in the associated coverage area. In the uplink, each remote antenna unit 404 receives one or more uplink radio frequency signals transmitted from any mobile devices 408 in the associated coverage area, generates one or more uplink streams of digital IQ samples derived from the received one or more uplink radio frequency signals, and transmits them to the master unit 402.

Each remote antenna unit 404 can be communicatively coupled directly to one or more master units 402 or indirectly via one or more other remote antenna units 404 and/or via one or more intermediate units 416 (also referred to as “expansion units” or “transport expansion nodes”). The latter approach can be done, for example, in order to increase the number of remote antenna units 404 that a single master unit 402 can feed, to increase the master-unit-to-remote-antenna-unit distance, and/or to reduce the amount of cabling needed to couple a master unit 402 to its associated remote antenna units 404. The expansion units are coupled to the master unit 402 via one or more cables 421.

In the example DAS 400 shown in FIG. 4, a remote antenna unit 404 is shown having another co-located remote antenna unit 405 (also referred to herein as an “extension unit”) communicatively coupled to it. Subtending a co-located extension remote antenna unit 405 from another remote antenna unit 404 can be done in order to expand the number of frequency bands that are radiated from that same location and/or to support MIMO service (for example, where different co-located remote antenna units radiate and receive different MIMO streams for a single MIMO frequency band). The remote antenna unit 404 is communicatively coupled to the “extension” remote antenna units 405 using a fiber optic cable, a multi-conductor cable, coaxial cable, or the like. In such an implementation, the remote antenna units 405 are coupled to the master unit 402 of the DAS 400 via the remote antenna unit 404.

In some examples, one or more components of the DAS 400 include the digital interference cancellation circuit 103 and can be configured to apply the calibration techniques as described above. For example, one or more remote antenna units 404, 405 can include the digital interference cancellation circuit 103 in order to cancel, reduce, attenuate, or eliminate interference from the signals received in the uplink path of the remote antenna units 404, 405.

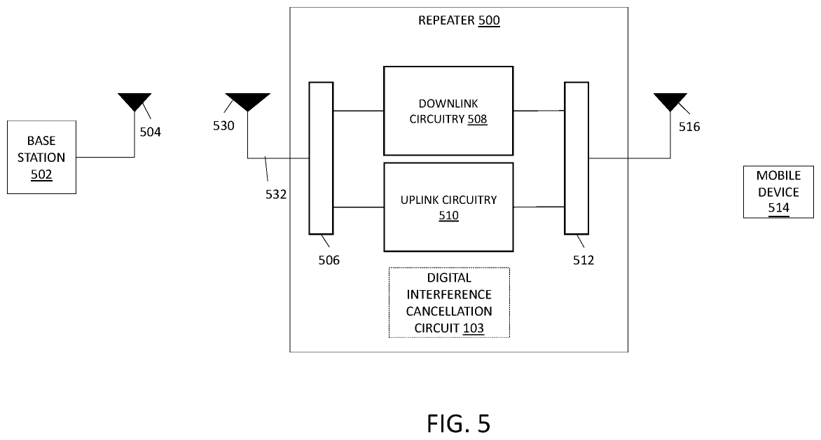

Other types of radio frequency distribution systems can also benefit from the digital interference cancellation circuit and calibration techniques described above. FIG. 5 illustrates an example of a single-node repeater 500 that includes the digital interference cancellation circuit 103 as discussed above with respect to FIGS. 1-2.

In the exemplary embodiment shown in FIG. 5, the single-node repeater 500 is coupled to one or more base stations 502 using a donor antenna 530.

The single-node repeater 500 comprises a first duplexer 506 having a common port that is coupled to the donor antenna 530 via a cable 532, a downlink port that is coupled to downlink circuitry 508, and an uplink port that is coupled to uplink circuitry 510. The single-node repeater 500 comprises a second duplexer 512 having a common port that is coupled to the coverage antenna 516, a downlink port that is coupled to the downlink circuitry 508, and an uplink port that is coupled to the uplink circuitry 510.

In general, the single-node repeater 500 is configured to receive one or more downlink signals from one or more base stations 502. Each base station downlink signal includes one or more radio frequency channels used for communicating in the downlink direction with user equipment 514 over the relevant one or more wireless air interfaces. The downlink circuitry 508 is configured to amplify the downlink signals received at the repeater 500 and re-radiate the amplified downlink signals via the coverage antenna 516. As a part of doing this, the downlink circuitry 508 can be configured to filter the downlink signals to separate out the individual channels, individually amplify each filtered downlink channel signal, combine the individually amplified downlink channel signals, and re-radiate the resulting combined signal.

Similar processing is performed in the uplink. The single-node repeater 500 is configured to receive one or more uplink signals from mobile device 514. Each mobile device uplink signal includes one or more radio frequency channels used for communicating in the uplink direction with one or more base stations 502 over the relevant one or more wireless air interfaces. The uplink circuitry 510 is configured to amplify the uplink signals received at the repeater 500 and re-radiate the amplified uplink signals via the donor antenna 530. As a part of doing this, the uplink circuitry 510 can be configured to filter the uplink signals to separate out the individual channels, individually amplify each filtered uplink channel signal, combine the individually amplified uplink channel signals, and re-radiate the resulting combined signal.

The single-node repeater 500 can be configured to implement one or more features to provide sufficient isolation between the donor antenna 530 and the coverage antenna 516. These features can include gain control circuitry and adaptive cancellation circuitry. Other features can be implemented. These features can be implemented in one or more of the downlink circuitry 508 and/or the uplink circuitry 510. These features can also be implemented in separate circuitry.

In some examples, the single-node repeater 500 can include one or more digital interference cancellation circuits 103 and can be configured to apply the calibration techniques as described above. For example, the single-node repeater 500 can include the digital interference cancellation circuit 103 in order to cancel, reduce, attenuate, or eliminate interference from the signals received via the coverage antenna 516 and/or signals received via the donor antenna 530.

The various circuitry and features of the single-node repeater 500 can be implemented in analog circuitry, digital circuitry, or combinations of analog circuitry and digital circuitry. The downlink circuitry 508 and uplink circuitry 510 can comprise one or more appropriate connectors, attenuators, combiners, splitters, amplifiers, filters, duplexers, analog-to-digital converters, digital-to-analog converters, electrical-to-optical converters, optical-to-electrical converters, mixers, field-programmable gate arrays (FPGAs), microprocessors, transceivers, framers, etc., to implement the features described above. Also, the downlink circuitry 508 and uplink circuitry 510 may share common circuitry and/or components.

In various aspects, system elements, method steps, or examples described throughout this disclosure (such as the digital interface cancellation circuit, distributed antenna system, repeater, or components thereof, for example) may be implemented on one or more computer systems, field programmable gate array (FPGA), application specific integrated circuit (ASIC) or similar devices comprising hardware executing code to realize those elements, processes, or examples, said code stored on a non-transient data storage device. These devices include or function with software programs, firmware, or other computer readable instructions for carrying out various methods, process tasks, calculations, and control functions.

These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a communications device, comprising: a transmit signal path; a receive signal path; a duplexer communicatively coupled to the transmit signal path and the receive signal path, wherein the duplexer is configured to provide an analog transmit signal to an antenna, wherein the duplexer is configured to provide an analog receive signal to the receive signal path; a feedback signal path communicatively coupled to the transmit signal path, wherein a portion of the analog transmit signal is decoupled into the feedback signal path from the transmit signal path as a feedback signal; analog-to-digital converters configured to convert the feedback signal to a digital feedback signal and the analog receive signal to a digital receive signal; a digital interference cancellation circuit configured to receive the digital feedback signal and the digital receive signal, wherein the digital interference cancellation circuit is configured to: modify the amplitude and phase of the digital feedback signal to generate a modified feedback signal; compensate the modified feedback signal for an impulse response of a coupling channel between the transmit signal path and the receive signal path to generate a compensated, modified feedback signal; and combine the compensated, modified feedback signal with the digital receive signal, wherein combination of the compensated, modified feedback signal with the receive signal cancels, reduces, attenuates, or eliminates inference in the digital receive signal.

Example 2 includes the communications device of Example 1, wherein the transmit signal path comprises: a digital-to-analog converter configured to convert a digital transmit signal to the analog transmit signal; a power amplifier communicatively coupled to the digital-to-analog converter, wherein the power amplifier is configured to adjust the amplitude of the analog transmit signal; a first directional coupler communicatively coupled to the power amplifier, wherein the first directional coupler is configured to decouple a portion of the analog transmit signal into the feedback signal path from the transmit signal path; wherein the feedback signal path comprises: a first analog-to-digital converter communicatively coupled to the first directional coupler and configured to receive the feedback signal, wherein the first analog-to-digital converter is configured to convert the feedback signal to the digital feedback signal; wherein the receive signal path comprises: a low-noise amplifier communicatively coupled to the duplexer and configured to receive the analog receive signal from the duplexer and adjust the amplitude of the analog receive signal; and a second analog-to-digital converter communicatively coupled to the low-noise amplifier, wherein the second analog-to-digital converter is configured to receive the analog receive signal from the low-noise amplifier and convert the analog receive signal to the digital receive signal. Example 3 includes the communications device of any of Examples 1-2, wherein the digital cancellation circuit comprises: a feedback signal path including: a first amplitude-offset block configured to modify the amplitude of the digital feedback signal; a phase shifter configured to modify the phase of the digital feedback signal; and a pre-convolution circuit configured to convolute the modified feedback signal with the impulse response of the coupling channel between the transmit signal path and the receive signal path to generate the compensated, modified feedback signal; an adaptive filter configured to modify the amplitude and/or phase of the compensated, modified feedback signal according to a transfer function of the adaptive filter, wherein the transfer function of the adaptive filter is statically calibrated using a bandwidth-limited White Gaussian Noise signal; a receive signal path including: a second amplitude-offset block configured to modify the amplitude of the digital receive signal; a digital summation communicatively coupled to the adaptive filter, wherein the digital summation is configured to combine the compensated, modified feedback signal with the digital receive signal.

Example 4 includes the communications device of any of Examples 1-2, wherein the digital cancellation circuit comprises: a feedback signal path including: a first amplitude-offset block configured to modify the amplitude of the digital feedback signal; a phase shifter configured to modify the phase of the digital feedback signal; and an adaptive filter configured to modify the amplitude and/or phase of the modified feedback signal according to a transfer function of the adaptive filter, wherein the transfer function of the adaptive filter is statically calibrated using a bandwidth-limited White Gaussian Noise signal to compensate the modified feedback signal for the impulse response of a coupling channel between the transmit signal path and the receive signal path; a receive signal path including: a second amplitude-offset block configured to modify the amplitude of the digital receive signal; a digital summation communicatively coupled to the adaptive filter, wherein the digital summation is configured to combine the compensated, modified feedback signal with the digital receive signal.

Example 5 includes the communications device of any of Examples 1-4, further comprising an internal signal generator, further comprising an internal signal generator, wherein the communications device is configured to dynamically calibrate a first amplitude-offset block, a second amplitude-offset block, and/or a phase shifter of the digital interference cancellation circuit using the internal signal generator.

Example 6 includes the communications device of any of Examples 1-5, wherein the transmit signal path comprises: a directional coupler configured to be coupled to a White Gaussian Noise signal generator, wherein the directional coupler is configured to inject the White Gaussian Noise signal into the transmit signal path during calibration; and a switch coupled to a digital-to-analog converter in the transmit signal path, wherein the switch is configurable between a first configuration and a second configuration, wherein in the first configuration the switch is communicatively coupled to the direction coupler, wherein in the second configuration the switch is communicatively coupled to a power amplifier in the transmit signal path.

Example 7 includes the communications device of Example 6, wherein the bandwidth-limited White Gaussian Noise signal is generated by a signal generator of a production testbench or an internal signal generator of the communications device.

Example 8 includes the communications device of any of Examples 1-7, wherein the impulse response of a coupling channel between the transmit signal path and the receive signal path includes an impulse response of the duplexer and an impulse response of one or more radio frequency components in the receive signal path.

Example 9 includes a digital interference cancellation circuit of a communications device, comprising: a feedback signal path comprising: a first amplitude-offset block configured to equalize a power level of a digitized feedback signal, wherein the digitized feedback signal is derived from a transmit signal from a transmit path of a communications device; a phase shifter configured to apply a phase offset to the digitized feedback signal to generate a modified feedback signal; a pre-convolution circuit configured to convolute the modified feedback signal with an impulse response of a coupling channel between a transmit signal path and a receive signal path of the communications device; and a receive signal path comprising: a second amplitude-offset block configured to equalize a power level of a digitized receive signal, wherein the digitized receive signal is derived from a receive signal from a duplexer of the communications device; and a digital summation configured to combine the convoluted, modified feedback signal with the digitized receive signal to cancel, reduce, attenuate, or eliminate interference from the digitized receive signal.

Example 10 includes the digital interference cancellation circuit of Example 9, wherein the feedback signal path further comprises a first windowing circuit configured to window the digitized feedback signal to produce a windowed, digitized feedback signal, wherein the windowed, digitized feedback signal is provided to the first amplitude-offset block; wherein the receive signal path further comprises a second windowing circuit configured to window the digitized receive signal to produce a windowed digitized feedback signal, wherein the windowed, digitized receive signal is provided to the second amplitude-offset block.

Example 11 includes the digital interference cancellation circuit of any of Examples 9-10, wherein the feedback signal path further comprises an adaptive filter communicatively coupled between the pre-convolution circuit and the digital summation, wherein the adaptive filter is configured to modify the amplitude and/or phase of the convoluted, modified feedback signal according to a transfer function of the adaptive filter, wherein the transfer function of the adaptive filter is statically calibrated using a bandwidth-limited White Gaussian Noise signal.

Example 12 includes the digital interference cancellation circuit of Example 11, wherein the bandwidth-limited White Gaussian Noise signal is generated by a signal generator of a production testbench and injected into the transmit signal path of the communications device via a second directional coupler communicatively coupled between a power amplifier and a first directional coupler in the transmit path of the communications device.

Example 13 includes the digital interference cancellation circuit of Example 11, wherein the bandwidth-limited White Gaussian Noise signal is generated by an internal signal generator of the communications device and injected into the transmit signal path of the communications device via a second directional coupler communicatively coupled between a power amplifier and a first directional coupler in the transmit path of the communications device.

Example 14 includes the digital interference cancellation circuit of any of Examples 11-13, wherein a processor is configured to dynamically calibrate the first amplitude-offset block, the second amplitude-offset block, and/or the phase shifter using an internal signal generator of the communications device.

Example 15 includes the digital interference cancellation circuit of any of Examples 11-14, wherein the impulse response of a coupling channel between the transmit signal path and the receive signal path includes an impulse response of the duplexer and an impulse response of one or more radio frequency components in the receive signal path.

Example 16 includes a digital interference cancellation circuit of a communications device, comprising: a feedback signal path comprising: a first amplitude-offset block configured to equalize a power level of a digitized feedback signal, wherein the digitized feedback signal is derived from a transmit signal from a transmit path of a communications device; a phase shifter configured to apply a phase offset to the digitized feedback signal to generate a modified feedback signal; an adaptive filter communicatively coupled between the phase shifter circuit and a digital summation, wherein the adaptive filter is configured to modify the amplitude and/or phase of the modified feedback signal according to a transfer function of the adaptive filter, wherein the transfer function of the adaptive filter is statically calibrated using a bandwidth-limited White Gaussian Noise signal to compensate the modified feedback signal for an impulse response of a coupling channel between the transmit signal path and a receive signal path of the communications device; and a receive signal path comprising: a second amplitude-offset block configured to equalize a power level of a digitized receive signal, wherein the digitized receive signal is derived from a receive signal from a duplexer of the communications device; and a digital summation configured to combine the compensated, modified feedback signal with the digitized receive signal to cancel, reduce, attenuate, or eliminate interference from the digitized receive signal.

Example 17 includes the digital interference cancellation circuit of Example 16, wherein the bandwidth-limited White Gaussian Noise signal is generated by a signal generator of a production testbench and injected into the transmit signal path of the communications device via a second directional coupler communicatively coupled between a power amplifier and a first directional coupler in the transmit path of the communications device.

Example 18 includes the digital interference cancellation circuit of Example 16, wherein the bandwidth-limited White Gaussian Noise signal is generated by an internal signal generator of the communications device and injected into the transmit signal path of the communications device via a second directional coupler communicatively coupled between a power amplifier and a first directional coupler in the transmit path of the communications device.

Example 19 includes the digital interference cancellation circuit of any of Examples 16-18, wherein a processor is configured to dynamically calibrate the first amplitude-offset block, the second amplitude-offset block, and/or the phase shifter using an internal signal generator of the communications device.

Example 20 includes the digital interference cancellation circuit of any of Examples 16-19, wherein the impulse response of a coupling channel between the transmit signal path and the receive signal path includes an impulse response of the duplexer and an impulse response of one or more radio frequency components in the receive signal path.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A communications device, comprising:
a transmit signal path;
a receive signal path;
a duplexer communicatively coupled to the transmit signal path and the receive signal path, wherein the duplexer is configured to provide an analog transmit signal to an antenna, wherein the duplexer is configured to provide an analog receive signal to the receive signal path;
a feedback signal path communicatively coupled to the transmit signal path, wherein a portion of the analog transmit signal is decoupled into the feedback signal path from the transmit signal path as a feedback signal;
analog-to-digital converters configured to convert the feedback signal to a digital feedback signal and the analog receive signal to a digital receive signal;
a digital interference cancellation circuit configured to receive the digital feedback signal and the digital receive signal, wherein the digital interference cancellation circuit is configured to:
modify the amplitude and phase of the digital feedback signal to generate a modified feedback signal;
compensate the modified feedback signal for an impulse response of a coupling channel between the transmit signal path and the receive signal path to generate a compensated, modified feedback signal; and
combine the compensated, modified feedback signal with the digital receive signal, wherein combination of the compensated, modified feedback signal with the receive signal cancels, reduces, attenuates, or eliminates inference in the digital receive signal.

2. The communications device of claim 1,
wherein the transmit signal path comprises:
a digital-to-analog converter configured to convert a digital transmit signal to the analog transmit signal;
a power amplifier communicatively coupled to the digital-to-analog converter, wherein the power amplifier is configured to adjust the amplitude of the analog transmit signal;
a first directional coupler communicatively coupled to the power amplifier, wherein the first directional coupler is configured to decouple a portion of the analog transmit signal into the feedback signal path from the transmit signal path;
wherein the feedback signal path comprises:
a first analog-to-digital converter communicatively coupled to the first directional coupler and configured to receive the feedback signal, wherein the first analog-to-digital converter is configured to convert the feedback signal to the digital feedback signal;
wherein the receive signal path comprises:
a low-noise amplifier communicatively coupled to the duplexer and configured to receive the analog receive signal from the duplexer and adjust the amplitude of the analog receive signal; and
a second analog-to-digital converter communicatively coupled to the low-noise amplifier, wherein the second analog-to-digital converter is configured to receive the analog receive signal from the low-noise amplifier and convert the analog receive signal to the digital receive signal.

3. The communications device of claim 1, wherein the digital cancellation circuit comprises:
a feedback signal path including:
a first amplitude-offset block configured to modify the amplitude of the digital feedback signal;
a phase shifter configured to modify the phase of the digital feedback signal; and
a pre-convolution circuit configured to convolute the modified feedback signal with the impulse response of the coupling channel between the transmit signal path and the receive signal path to generate the compensated, modified feedback signal;
an adaptive filter configured to modify the amplitude and/or phase of the compensated, modified feedback signal according to a transfer function of the adaptive filter, wherein the transfer function of the adaptive filter is statically calibrated using a bandwidth-limited White Gaussian Noise signal;
a receive signal path including:
a second amplitude-offset block configured to modify the amplitude of the digital receive signal;
a digital summation communicatively coupled to the adaptive filter, wherein the digital summation is configured to combine the compensated, modified feedback signal with the digital receive signal.

4. The communications device of claim 1, wherein the digital cancellation circuit comprises:
a feedback signal path including:
a first amplitude-offset block configured to modify the amplitude of the digital feedback signal;
a phase shifter configured to modify the phase of the digital feedback signal; and
an adaptive filter configured to modify the amplitude and/or phase of the modified feedback signal according to a transfer function of the adaptive filter, wherein the transfer function of the adaptive filter is statically calibrated using a bandwidth-limited White Gaussian Noise signal to compensate the modified feedback signal for the impulse response of a coupling channel between the transmit signal path and the receive signal path;
a receive signal path including:
a second amplitude-offset block configured to modify the amplitude of the digital receive signal;
a digital summation communicatively coupled to the adaptive filter, wherein the digital summation is configured to combine the compensated, modified feedback signal with the digital receive signal.

5. The communications device of claim 1, further comprising an internal signal generator, wherein the communications device is configured to dynamically calibrate a first amplitude-offset block, a second amplitude-offset block, and/or a phase shifter of the digital interference cancellation circuit using the internal signal generator.

6. The communications device of claim 1, wherein the transmit signal path comprises:
a directional coupler configured to be coupled to a White Gaussian Noise signal generator, wherein the directional coupler is configured to inject the White Gaussian Noise signal into the transmit signal path during calibration; and
a switch coupled to a digital-to-analog converter in the transmit signal path, wherein the switch is configurable between a first configuration and a second configuration, wherein in the first configuration the switch is communicatively coupled to the direction coupler, wherein in the second configuration the switch is communicatively coupled to a power amplifier in the transmit signal path.

7. The communications device of claim 6, wherein the bandwidth-limited White Gaussian Noise signal is generated by a signal generator of a production testbench or an internal signal generator of the communications device.

8. The communications device of claim 1, wherein the impulse response of a coupling channel between the transmit signal path and the receive signal path includes an impulse response of the duplexer and an impulse response of one or more radio frequency components in the receive signal path.

9. A digital interference cancellation circuit of a communications device, comprising:
a feedback signal path comprising:
a first amplitude-offset block configured to equalize a power level of a digitized feedback signal, wherein the digitized feedback signal is derived from a transmit signal from a transmit path of a communications device;
a phase shifter configured to apply a phase offset to the digitized feedback signal to generate a modified feedback signal;
a pre-convolution circuit configured to convolute the modified feedback signal with an impulse response of a coupling channel between a transmit signal path and a receive signal path of the communications device; and
a receive signal path comprising:
a second amplitude-offset block configured to equalize a power level of a digitized receive signal, wherein the digitized receive signal is derived from a receive signal from a duplexer of the communications device; and
a digital summation configured to combine the convoluted, modified feedback signal with the digitized receive signal to cancel, reduce, attenuate, or eliminate interference from the digitized receive signal.

10. The digital interference cancellation circuit of claim 9, wherein the feedback signal path further comprises a first windowing circuit configured to window the digitized feedback signal to produce a windowed, digitized feedback signal, wherein the windowed, digitized feedback signal is provided to the first amplitude-offset block;
wherein the receive signal path further comprises a second windowing circuit configured to window the digitized receive signal to produce a windowed digitized feedback signal, wherein the windowed, digitized receive signal is provided to the second amplitude-offset block.

11. The digital interference cancellation circuit of claim 9, wherein the feedback signal path further comprises an adaptive filter communicatively coupled between the pre-convolution circuit and the digital summation, wherein the adaptive filter is configured to modify the amplitude and/or phase of the convoluted, modified feedback signal according to a transfer function of the adaptive filter, wherein the transfer function of the adaptive filter is statically calibrated using a bandwidth-limited White Gaussian Noise signal.

12. The digital interference cancellation circuit of claim 11, wherein the bandwidth-limited White Gaussian Noise signal is generated by a signal generator of a production testbench and injected into the transmit signal path of the communications device via a second directional coupler communicatively coupled between a power amplifier and a first directional coupler in the transmit path of the communications device.

13. The digital interference cancellation circuit of claim 11, wherein the bandwidth-limited White Gaussian Noise signal is generated by an internal signal generator of the communications device and injected into the transmit signal path of the communications device via a second directional coupler communicatively coupled between a power amplifier and a first directional coupler in the transmit path of the communications device.

14. The digital interference cancellation circuit of claim 11, wherein a processor is configured to dynamically calibrate the first amplitude-offset block, the second amplitude-offset block, and/or the phase shifter using an internal signal generator of the communications device.

15. The digital interference cancellation circuit of claim 11, wherein the impulse response of a coupling channel between the transmit signal path and the receive signal path includes an impulse response of the duplexer and an impulse response of one or more radio frequency components in the receive signal path.

16. A digital interference cancellation circuit of a communications device, comprising:
a feedback signal path comprising:
a first amplitude-offset block configured to equalize a power level of a digitized feedback signal, wherein the digitized feedback signal is derived from a transmit signal from a transmit path of a communications device;
a phase shifter configured to apply a phase offset to the digitized feedback signal to generate a modified feedback signal;
an adaptive filter communicatively coupled between the phase shifter circuit and a digital summation, wherein the adaptive filter is configured to modify the amplitude and/or phase of the modified feedback signal according to a transfer function of the adaptive filter, wherein the transfer function of the adaptive filter is statically calibrated using a bandwidth-limited White Gaussian Noise signal to compensate the modified feedback signal for an impulse response of a coupling channel between the transmit signal path and a receive signal path of the communications device; and
a receive signal path comprising:
a second amplitude-offset block configured to equalize a power level of a digitized receive signal, wherein the digitized receive signal is derived from a receive signal from a duplexer of the communications device; and
a digital summation configured to combine the compensated, modified feedback signal with the digitized receive signal to cancel, reduce, attenuate, or eliminate interference from the digitized receive signal.

17. The digital interference cancellation circuit of claim 16, wherein the bandwidth-limited White Gaussian Noise signal is generated by a signal generator of a production testbench and injected into the transmit signal path of the communications device via a second directional coupler communicatively coupled between a power amplifier and a first directional coupler in the transmit path of the communications device.

18. The digital interference cancellation circuit of claim 16, wherein the bandwidth-limited White Gaussian Noise signal is generated by an internal signal generator of the communications device and injected into the transmit signal path of the communications device via a second directional coupler communicatively coupled between a power amplifier and a first directional coupler in the transmit path of the communications device.

19. The digital interference cancellation circuit of claim 16, wherein a processor is configured to dynamically calibrate the first amplitude-offset block, the second amplitude-offset block, and/or the phase shifter using an internal signal generator of the communications device.

20. The digital interference cancellation circuit of claim 16, wherein the impulse response of a coupling channel between the transmit signal path and the receive signal path includes an impulse response of the duplexer and an impulse response of one or more radio frequency components in the receive signal path.
